(19) United States
(12) Patent Application Publication
(10) Pub. No.: US 2026/0066420 A1
(43) Pub. Date: Mar. 5, 2026

(54) VEHICLE BATTERY CASE

(71) Applicant: TOYOTA JIDOSHA KABUSHIKI KAISHA, Toyota-shi (JP)

(72) Inventor: Naoto KAGEYAMA, Nagoya-shi (JP)

(73) Assignee: TOYOTA JIDOSHA KABUSHIKI KAISHA, Toyota-shi (JP)

(21) Appl. No.: 19/169,185

(22) Filed: Apr. 3, 2025

(30) Foreign Application Priority Data
Aug. 29, 2024 (JP) 2024-147542

(51) Int. Cl. H01M 50/24; H01M 50/204; H01M 50/249; H01M 50/682

(52) U.S. Cl. CPC H01M 50/24; H01M 50/204; H01M 50/249; H01M 50/682

(57) ABSTRACT

A battery case of a battery includes a lower case. A recess is provided near a corner on a rear side of a bottom plate of the lower case in a front-rear direction of a vehicle, and the lower case can store water in the recess. This allows the battery case to increase the amount of water that can immerse a battery module, and restrain the battery module from being immersed in water as compared to a case in which no recess is provided in the bottom plate.

### CROSS-REFERENCE TO RELATED APPLICATION

This application claims priority to Japanese Patent Application No. 2024-147542 filed on Aug. 29, 2024. The disclosure of the above-identified application, including the specification, drawings, and claims, is incorporated by reference herein in its entirety.

### BACKGROUND

### 1. Technical Field

The present disclosure relates to a vehicle battery case.

### 2. Description of Related Art

Japanese Unexamined Patent Application Publication No. 2021-123227 (JP 2021-123227 A) describes a battery pack that is installed on a vehicle floor. The battery pack includes a plurality of battery cells arranged in a battery pack case. The battery pack case includes a lower case in which the battery cells are arranged side by side, and an upper case that isolates the space in the lower case in which the battery cells are arranged from the surrounding area. In addition, the lower case of the battery pack case is fixed to the vehicle floor.

### SUMMARY

Incidentally, in a vehicle, a lower part of the vehicle body to which the battery case is attached may be splashed with rainwater that has accumulated on the road surface or may be immersed in rainwater that has accumulated on the road surface. For this reason, rainwater easily adheres to the battery case, and the adhered rainwater (water) may enter the inside of the battery case. Due to the water that enters the inside of the battery case and accumulates therein, there is a concern that the accumulated water may adhere to the battery pack inside the battery case and to the battery cells inside the battery pack.

When the battery pack and the battery cell inside the battery pack are immersed in water, the battery performance will be reduced. For this reason, there is room for improvement in terms of restraining water from adhering to the battery cell or restraining the battery cell from being immersed in water in the battery case.

The present disclosure has been made in consideration of the above circumstances. It is an object of the present disclosure to provide a vehicle battery case that can restrain water that has entered the inside of the battery case from adhering to battery cells, etc.

To achieve the object, a vehicle battery case according to a first aspect includes a case body that has a rectangular contour and an internal space in which a battery module is housed by being mounted on an inner surface side of a bottom plate. The battery module includes a plurality of stacked battery cells. The case body is provided with a recess that is open upward at a corner on the inner surface side of the bottom plate.

In the vehicle battery case according to the first aspect, the battery module is housed in the internal space of the case body that has the rectangular contour. The battery module includes a plurality of stacked battery cells and is mounted on the inner surface side of the bottom plate of the case body.

In the case body, the recess that is open upward is provided at the corner on the inner surface side of the bottom plate. Therefore, the case body can store, in the recess provided in the bottom plate, some of the water that has entered the inside of the case body and accumulates on the bottom plate, and in the case body, it is possible to restrain the battery module and the battery cells from being immersed in the water when water enters the inside of the case body, as compared to a case in which the recess is not provided.

In the vehicle battery case according to a second aspect, in the first aspect, the recess is provided on a rear side of the bottom plate in a front-rear direction of a vehicle.

In the vehicle battery case according to the second aspect, the recess is provided on the rear side of the bottom plate of in the front-rear direction of the vehicle. Therefore, in the case body, when water accumulates on the bottom plate, the water is allowed to enter the recess on the rear side of the bottom plate in the front-rear direction of the vehicle, so that it is possible to effectively restrain the battery module and the battery cells from being immersed in the water that has entered.

In the vehicle battery case according to a third aspect, in the first or second aspect, the case body is provided with a water amount detection unit that detects an amount of water accumulated on the bottom plate on a front side in the front-rear direction of the vehicle.

In the vehicle battery case according to the third aspect, the case body is provided with the water amount detection unit that detects the amount of water accumulated on the bottom plate on the front side in the front-rear direction of the vehicle. Accordingly, it is possible to detect that water enters the case body and restrain the battery module and the battery cells from being immersed in the water that has entered.

According to the present disclosure, providing the recess on the rear side of the bottom plate in the front-rear direction of the vehicle makes it possible to store in the recess some of the water that has entered. Therefore, the vehicle battery case has the effect of restraining the water that has entered from adhering to the battery module and the battery cells or the battery module and the battery cells from being immersed in the water as compared to a case in which no recess is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a battery according to an embodiment;

FIG. 2 is a plan view illustrating a main portion of a lower case on a rear side in a front-rear direction of a vehicle;

FIG. 3 is a perspective view illustrating the main portion of the lower case on the rear side in the front-rear direction of the vehicle;

FIG. 4 is a perspective view illustrating a main portion of the lower case on a front side in the front-rear direction of the vehicle; and

FIG. 5 is a perspective view illustrating the main portion of the lower case on the front side in the front-rear direction of the vehicle as viewed in a different direction than FIG. 4.

### DETAILED DESCRIPTION OF EMBODIMENTS

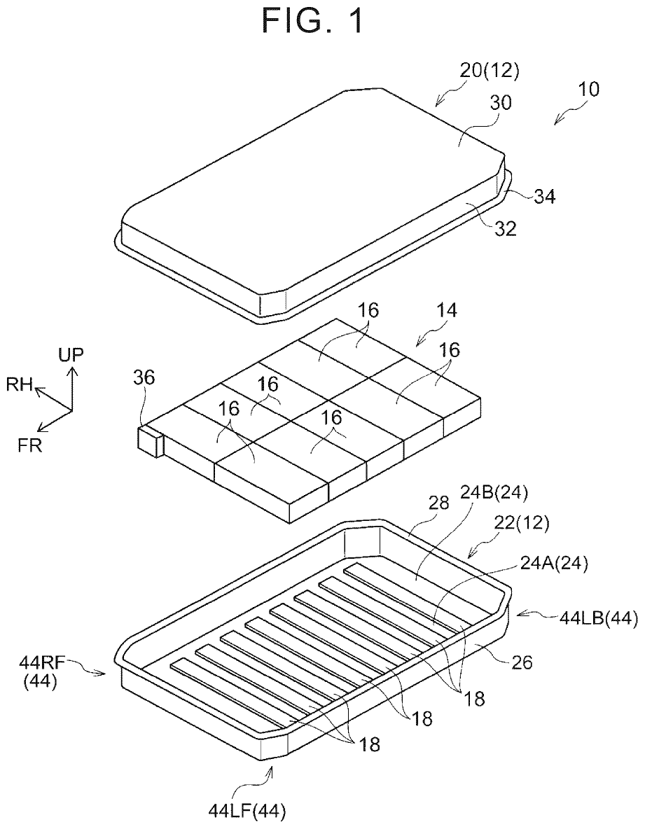

A vehicle battery case according to an embodiment of the present disclosure will be described in detail below with reference to the drawings. The vehicle battery case is mounted in a vehicle for use. FIG. 1 is a perspective view illustrating a schematic configuration of a battery (battery pack) 10 according to the embodiment. In the drawings, a forward direction in a front-rear direction of the vehicle is indicated by an arrow FR, a rightward direction in a width direction of the vehicle is indicated by an arrow RH, and an upward direction is indicated by an arrow UP.

The battery 10 is mounted, for example, in a vehicle (not shown) that includes an electric motor serving as a drive source for traveling, and outputs direct current (DC) power that can be used to drive the electric motor. The vehicle in which the battery 10 is mounted includes a hybrid electric vehicle (HEV), a plug-in hybrid electric vehicle (PHEV), a battery electric vehicle (BEV), and the like.

As illustrated in FIG. 1, the battery 10 includes a battery case 12 serving as the vehicle battery case and a case body according to the embodiment, and a battery pack 14 housed in the battery case 12. The battery case 12 has a substantially rectangular box shape, is disposed below a floor panel serving as a floor of the vehicle and above an undercover, and is attached to a vehicle body (they are not shown).

The battery case 12 includes an upper case 20 and a lower case 22. The upper case 20 and the lower case 22 are opposed to each other with the upper case 20 positioned on the upper side and the lower case 22 positioned on the lower side.

The lower case 22 includes a bottom plate 24 that is substantially rectangular in plan view. The lower case 22 includes a peripheral wall 26 erected around the bottom plate 24. A flange portion 28 is provided around substantially the entire circumference of the peripheral wall 26 such that the upper portion of the lower case 22 is bent outward of the lower case 22. The lower case 22 includes the bottom plate 24, the peripheral wall 26, and the flange portion 28 that are integrally provided, and the lower case 22 has a substantially rectangular tray shape (or a basin shape).

The upper case 20 includes a top plate 30 that is substantially rectangular in plan view. In addition, the upper case 20 includes a peripheral wall 32 that projects downward around the top plate 30. In the upper case 20, a flange portion 34 is provided around substantially the entire circumference of the peripheral wall 32 such that an end portion (lower end portion) of the upper case 20 is bent outward of the upper case 20. The upper case 20 includes the top plate 30, the peripheral wall 32, and the flange portion 34 that are integrally provided.

The battery case 12 is stacked such that the flange portion 34 of the upper case 20 and the flange portion 28 of the lower case 22 face each other. In addition, in the battery case 12, the flange portion 34 of the upper case 20 and the flange portion 28 of the lower case 22 are assembled by fastening them together using fastening means such as bolts and nuts, and the internal space is sealed from the surroundings (not shown).

In the battery case 12, the boundary between the top plate 30 and the peripheral wall 32 of the upper case 20 and the boundary between the bottom plate 24 and the peripheral wall 26 of the lower case 22, etc. are chamfered, so that the outer surface side of the battery case 12 is curved.

In the battery 10, a battery pack 14 is housed in the internal space of the battery case 12. At this time, the battery pack 14 is covered from the top and bottom by the top plate 30 and the bottom plate 24, and is surrounded by the peripheral walls 26, 32. The battery case 12 functions as a battery pack case in which the battery pack 14 is housed.

The battery pack 14 includes one or more battery modules 16. The battery modules 16 each include a plurality of battery cells (not shown), and the battery cells are stacked. The battery case 12 houses the battery modules 16. The battery case 12 may be in a form in which the battery case 12 houses only one battery module 16, rather than multiple battery modules 16.

In the battery 10 (battery pack 14), for example, the battery modules 16 are connected in parallel or in series. In the battery pack 14, auxiliary equipment 36 is provided together with the battery modules 16. The auxiliary equipment 36 includes various sensors and a controller (not shown) that controls, based on information detected by the sensors, the operation of the battery modules 16 and the battery cells included in the battery modules 16. In the battery 10 (battery pack 14), DC power of a required voltage is output during discharging, and DC power of a required voltage is received, so that each of the battery cells of the battery modules 16 is charged.

In the battery case 12, a plurality of mounting portions 18 is provided on the bottom plate 24 of the lower case 22. The mounting portions 18 each have, for example, a rectangular block (or plate) shape. The longitudinal direction of each of the mounting portions 18 is aligned with the width direction of the vehicle. The mounting portions 18 are arranged at predetermined intervals in the front-rear direction of the vehicle.

In the lower case 22, a portion of the bottom plate 24 (peripheral edge portion of the bottom plate 24) between the mounting portions 18 and the peripheral wall 26 is a lower portion (deep bottom portion) 24B that is lower than an upper surface 24A that is a central portion of the bottom plate 24. The battery modules 16 are mounted on the mounting portions 18, arranged on the bottom plate 24 of the lower case 22, and thus disposed in the battery case 12.

Accordingly, the battery modules 16 are disposed in the battery case 12 such that the battery modules 16 are raised by the height of the mounting portions 18 relative to the upper surface 24A of the bottom plate 24. In addition, the bottom plate 24 of the battery case 12 has, in the peripheral edge portion thereof, the lower portion 24B in contrast to the upper surface 24A on which the battery pack 14 is disposed, so that the peripheral edge portion is even lower relative to the undersurface of the battery pack 14.

The battery case 12 has a substantially rectangular box shape, and has corners 44 at its four corners. The four corners 44 are a corner 44RF that is on the front side in the front-rear direction of the vehicle and on the right side in the width direction of the vehicle, a corner 44LF that is on the front side in the front-rear direction of the vehicle and on the left side in the width direction of the vehicle, a corner 44RB that is on the rear side in the front-rear direction of the vehicle and on the right side in the width direction of the vehicle, and a corner 44LB that is on the rear side in the front-rear direction of the vehicle and on the left side in the width direction of the vehicle.

In the lower case 22 of the battery case 12, recesses 40 are provided in a few of the corners 44 of the bottom plate 24. The recesses 40 serve as volume increase portions. Furthermore, in the lower case 22, bead portions as projections and raised portions are provided in a few of the corners 44 of the bottom plate 24 among the corners 44 in which the recesses 40 are not provided.

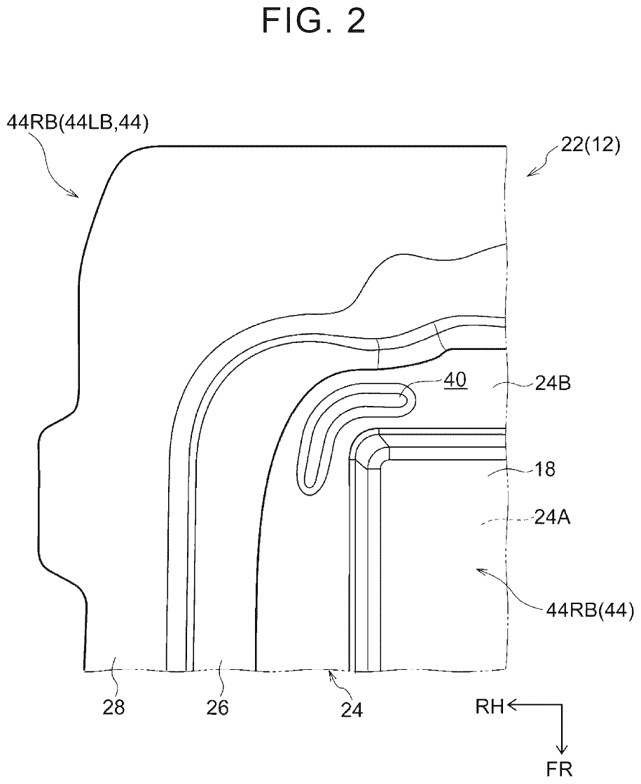

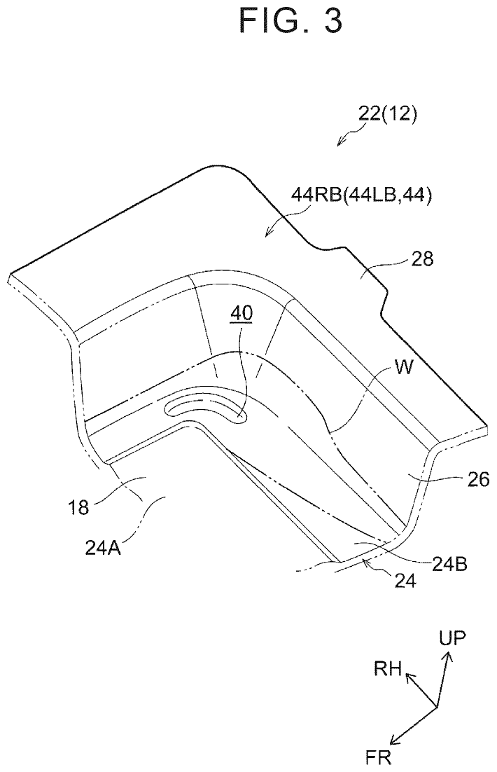

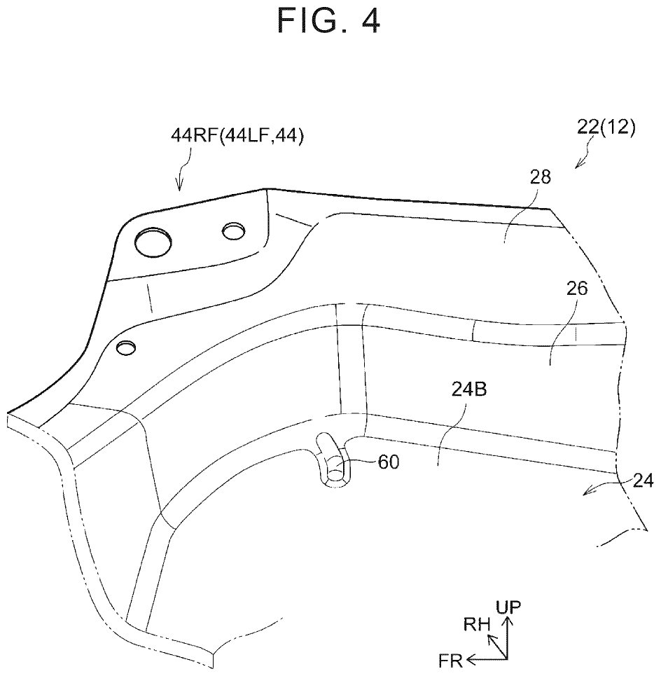

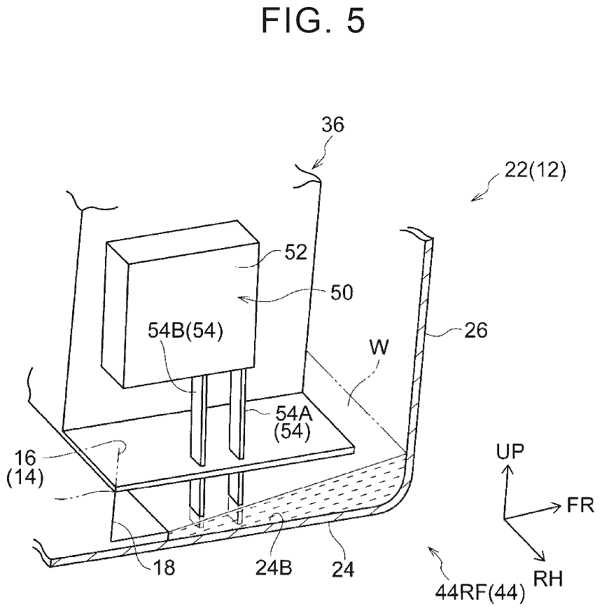

FIG. 2 is a plan view illustrating a main portion of the lower case 22 on the rear side in the front-rear direction of the vehicle, and FIG. 3 is a perspective view illustrating the main portion of the lower case 22 on the rear side in the front-rear direction of the vehicle. FIG. 4 is a perspective view illustrating a main portion of the lower case 22 on the front side in the front-rear direction of the vehicle, and FIG. 5 is a perspective view illustrating the main portion of the lower case 22 on the front side in the front-rear direction of the vehicle as viewed in a different direction than FIG. 4. In FIG. 3, the corner 44RB is illustrated as viewed from diagonally above on the right front side. In FIG. 4, the corner 44RF is illustrated as viewed from diagonally above on the left rear side. In FIG. 5, a portion near the corner 44RF is illustrated as viewed from diagonally above on the right front side.

As shown in FIGS. 2 and 3, the recess 40 is provided in the lower portion 24B of the bottom plate 24 of the lower case 22 on the rear side in the front-rear direction of the vehicle. The recess 40 is provided near each of the corner 44RB and the corner 44LB in the lower case 22. Note that the recess 40 near the corner 44RB and the recess 40 near the corner 44LB have the same configuration, and the following mainly describes the recess 40 near the corner 44RB, and omits the description of the recess 40 near the corner 44LB.

The recess 40 is provided in the lower portion 24B of the bottom plate 24, and has a groove shape (bottomed shape) that is open upward. The recess 40 extends from the corner 44RB side toward the front side in the front-rear direction of the vehicle, and also extends from the corner 44RB side toward the left side in the width direction of the vehicle. Therefore, the recess 40 is substantially L-shaped when viewed from above. In the lower case 22, the recess 40 is provided in the bottom plate 24, so that the volume of the lower case 22 is increased by the volume of the recess 40.

In addition, in the lower case 22, because the recess is provided, a bead portion (not shown) is provided so as to project from the undersurface of the bottom plate 24, and the bead portion corresponding to the recess 40 is substantially L-shaped and projects from the undersurface. Therefore, the bead portion corresponding to the recess 40 has a portion extending in the width direction of the vehicle and a portion extending in the front-rear direction of the vehicle that are integrated together. As a result, even though the recess 40 is provided in the lower case 22, the plate thickness at the recess 40 is restrained from becoming thin and resulting in a decrease in strength.

As shown in FIG. 4, the bottom plate 24 of the lower case 22 is provided with the bead portion 60 as a projection and a raised portion at the lower portion 24B on the front side in the front-rear direction of the vehicle. In the lower case 22, the bead portions 60 are provided near the corners 44RF, 44LF. Note that the bead portion 60 near the corner 44RF and the bead portion 60 near the corner 44LF have the same basic configuration, and the following mainly describes the bead portion 60 near the corner 44RF, and omits the description of the bead portion 60 near the corner 44LF.

The bead portion 60 is provided in the lower portion 24B of the bottom plate 24 so as to project upward. The bead portion 60 is provided such that it extends toward the inner side in the width direction of the vehicle (left side in the width direction of the vehicle) as the bead portion 60 extends from the corner 44RF side toward the rear side in the front-rear direction of the vehicle. The bead portion 60 is inclined with respect to each of the front-rear direction of the vehicle and the width direction of the vehicle. Accordingly, in the lower case 22, the volume of the lower case 22 is increased by the volume of the bead portion 60 near the lower portion 24B of the bottom plate 24 in the front side in the front-rear direction of the vehicle.

Meanwhile, in the lower case 22 of the battery case 12, a water detection sensor (water level detection sensor) 50 serving as a water amount detection unit and a water detection unit is disposed. As Illustrated in FIG. 5, the water detection sensor 50 is disposed on the front side in the front-rear direction of the vehicle in the lower case 22, and is disposed, for example, near the bead portion 60 that is near the corner 44RF.

As one of the sensors disposed in the battery case 12, the water detection sensor 50 is disposed in the auxiliary equipment 36. The water detection sensor 50 includes a pair of electrodes 54 projecting downward from a sensor body 52, and each of the electrodes 54 projects from the sensor body 52 to the lower portion 24B of the bottom plate 24.

The electrodes 54 have the same length or one is longer than the other. In the water detection sensor 50, for example, an electrode 54A is longer than an electrode 54B. Accordingly, the water detection sensor 50 can detect that water has accumulated in the lower portion 24B of the bottom plate 24 of the lower case 22 when tips of the electrodes 54A, 54B are immersed in water W.

Next, an operation of the embodiment will be described.

The battery 10 includes the battery case 12. The battery case 12 includes the upper case 20 and the lower case 22. In the battery case 12, the battery modules 16 in which battery cells are stacked are disposed (fixed) on the lower case 22 and are covered by the upper case 20. Accordingly, the battery 10 includes the battery modules 16 (battery pack 14) housed in the battery case 12.

In the battery 10, each of the battery cells of the battery modules 16 is charged by receiving DC power of a required voltage. Furthermore, the battery 10 outputs DC power of a required voltage with the battery cells that have been charged.

In such a battery 10, when the water W adheres to the battery cells or the battery modules 16 in which the battery cells are stacked, or when the battery cells or the battery modules 16 are immersed in the water W, the battery performance will deteriorate. For this reason, in the battery 10, it is necessary to restrain the water W from adhering to the battery modules 16 or the battery modules 16 from being immersed in water W in order to restrain the deterioration of the battery performance or the like.

The battery 10 has the battery case 12 mounted on a lower part of the vehicle body. While the vehicle is traveling, rainwater that has accumulated on the road surface may splash onto the battery case 12, or the battery case 12 may be immersed in rainwater that has accumulated on the road surface. In the battery 10, as the water W seeps into the battery case 12, the water W accumulates on the bottom plate 24 of the lower case 22.

In the lower case 22, the peripheral edge portion of the bottom plate 24 is the lower portion 24B, and the lower portion 24B is lower than the upper surface 24A on which the battery modules 16 are mounted. Furthermore, in the lower case 22, the mounting portions 18 are disposed on the upper surface 24A, and the battery modules 16 are disposed on the mounting portions 18.

Therefore, in the battery 10, even if the water W enters the battery case 12, the water W accumulates in the lower portion 24B of the bottom plate 24, so that it is possible to restrain the water W from adhering to the battery modules 16 and restrain the battery modules 16 from being immersed in the water W.

On the other hand, as shown in FIGS. 2 and 3, the lower case 22 is provided with the recesses 40 in the lower portion 24B of the bottom plate 24, and the recesses 40 increase the volume of the portion near the lower portion 24B of the lower case 22. Therefore, in the battery case 12, the amount of the accumulated water W that reaches the battery modules 16 can be increased as compared to a case in which the recesses 40 are not provided in the lower portion 24B. Therefore, even if the water W enters the inside of the battery case 12, it is possible to effectively restrain the water W from adhering to the battery modules 16 and effectively restrain the battery modules 16 from being immersed in the water W.

Furthermore, in the vehicle, the rear side in the front-rear direction of the vehicle often becomes lower than the front side in the front-rear direction of the vehicle depending on the number of occupants and the amount of luggage loaded. In the lower case 22, the recesses 40 are provided on the rear side in the front-rear direction of the vehicle, so that it is possible to more effectively restrain the water W from adhering to the battery modules 16 and more effectively restrain the battery modules 16 from being immersed in the water W.

Furthermore, in the vehicle, when the vehicle is steered, an inertial force is generated in the width direction of the vehicle. For this reason, in the lower case 22, the amount of water tends to increase (changes greatly) near the left and right corners 44LB, 44RB. However, the recesses 40 are provided near the corners 44LB, 44RB. With this configuration, in the battery case 12, it is possible to even more effectively restrain the water W from adhering to the battery modules 16 and even more effectively restrain the battery modules 16 from being immersed in the water W.

In addition, in the event of an emergency of the vehicle, a load may be applied to the rear side in the front-rear direction or to the inner side in the vehicle width direction. In the lower case 22, because the substantially L-shaped recesses 40 are provided, the bead portions corresponding to the recesses 40 are provided. As a result, in the battery case 12, deformation of the lower case is restrained even when the lower case 22 receives a load on the rear side in the front-rear direction or the inner side in the width direction of the vehicle in the event of an emergency of the vehicle. Therefore, with the battery case 12, it is possible to protect the battery modules 16 in the event of an emergency of the vehicle or the like.

Meanwhile, the water detection sensor 50 is disposed in the lower case 22 so as to face the lower portion 24B of the bottom plate 24 on the front side in the front-rear direction of the vehicle. The water detection sensor 50 can detect that the water W has entered on the bottom plate 24 when both of the electrodes 54A, 54B are exposed to the water W or immersed in the water W. Therefore, even when the water W seeps into the battery case 12, the detection by the water detection sensor 50 makes it possible to limit the use of the battery 10 with the water W adhering to the battery modules 16.

In the vehicle, an inertial force is generated toward the front when the vehicle is decelerated, an inertial force is generated toward the rear when the vehicle is accelerated, and an inertial force is generated in the vehicle width direction when the vehicle is steered. In the lower case 22, when the water W adheres to the lower portion 24B, the water W flows (moves) due to an inertial force.

Therefore, in the battery case 12, the water detection sensor 50 is disposed on the front side in the front-rear direction of the vehicle where the recesses 40 are not provided, so that the water detection sensor 50 can efficiently detect the water W while the vehicle is traveling.

Furthermore, the lower case 22 is provided with the bead portions 60 near the corners 44RF, 44LF on the front side in the front-rear direction of the vehicle. The water detection sensor 50 is disposed near the corner 44RF where the bead portion 60 is provided. Therefore, in the battery case 12, even when the amount of the water W that reaches a portion of the lower portion 24B near the corner 44RF is small, the water detection sensor 50 can efficiently detect water entry.

Furthermore, in the lower case 22, the bead portions 60 are provided near the corners 44RF, 44LF of the bottom plate 24, and the bead portions 60 are inclined with respect to the front-rear direction of the vehicle and the width direction of the vehicle. Therefore, even when loads are input from the front or from the outside in the width direction of the vehicle in the event of an emergency of the vehicle, the battery case 12 can protect the battery modules 16 against these loads.

As described above, in the battery case 12, the recesses 40 are provided in the lower case 22 near the corners 44LB, 44RB on the rear side in the front-rear direction of the vehicle. Therefore, in the battery case 12, it is possible to restrain the battery modules 16 from being immersed in the water W as compared to a case in which the recesses 40 are not provided.

Moreover, in the battery case 12, the bead portions 60 are provided in the lower case 22 near the corners 44LF, 44RF on the front side in the front-rear direction of the vehicle, and the water detection sensor 50 is disposed near the corner 44RF. Therefore, in the battery case 12, it is possible to effectively detect that the water W has entered the inside of the battery case 12, and limit the charging and discharging operation with the battery modules 16 immersed in water.

Furthermore, in the battery case 12, the bead portions are provided so as to correspond to the recesses 40 on the rear side of the lower case 22 in the front-rear direction of the vehicle, and the bead portions 60 are provided on the front side in the front-rear direction of the vehicle. Therefore, in the battery case 12, it is possible to protect the battery modules 16 from loads input from the surroundings in the event of an emergency of the vehicle, etc.

In the embodiment described above, the recesses 40 are provided near the corners 44LB, 44RB on the rear side in the front-rear direction of the vehicle. However, in addition to being provided near the corners 44LB, 44RB, recesses may be provided in a substantially linear shape in a portion of the lower portion 24B that is between the corners 44LB, 44RB. Furthermore, in addition to being provided near the corners 44LB, 44RB, recesses may be provided in a substantially linear shape in portions of the lower portion 24B so as to extend from the corners 44LB, 44RB toward the front side in the front-rear direction of the vehicle. This makes it possible to increase the amount of water that can immerse the battery modules 16, thereby restraining the battery modules 16 from being immersed in the water W.

Furthermore, in the water detection sensor 50, the amount of water W that can be detected varies depending on the distance between the tip of the short electrode 54B and the upper surface of the lower portion 24B. Accordingly, the water detection sensor 50 may be configured such that the length of the electrode 54B is set depending on the amount of the water W to be detected. Therefore, in the battery case 12, it is possible to detect using the water detection sensor 50 whether the amount of the water W has reached a preset amount.

In the embodiment, the water detection sensor 50 is disposed near the corner 44RF. However, the water detection sensor 50 may be disposed near the corner 44LF, or may be disposed between the corners 44LF, 44RF (at the middle in the width direction of the vehicle).

What is claimed is:

1. A vehicle battery case comprising a case body that has a rectangular contour and an internal space in which a battery module is housed by being mounted on an inner surface side of a bottom plate, the battery module including a plurality of stacked battery cells, wherein the case body is provided with a recess that is open upward at a corner on the inner surface side of the bottom plate.

2. The vehicle battery case according to claim 1, wherein the recess is provided on a rear side of the bottom plate in a front-rear direction of a vehicle.

3. The vehicle battery case according to claim 1, wherein the case body is provided with a water amount detection unit that detects an amount of water accumulated on the bottom plate on a front side in a front-rear direction of a vehicle.
